(19) United States
(12) Patent Application Publication
(10) Pub. No.: US 2016/0077473 A1
(43) Pub. Date: Mar. 17, 2016

(54) IMAGE FORMING AND ERASING APPARATUS WITH MULTIPLE CONVEYANCE PATHS

(71) Applicants: KABUSHIKI KAISHA TOSHIBA, Tokyo (JP); TOSHIBA TEC KABUSHIKI KAISHA, Tokyo (JP)

(72) Inventors: Tokihiko Ise, Shizuoka (JP); Satoshi Kinouchi, Tokyo (JP); Takaho Watanabe, Shizuoka (JP); Ryota Saeki, Shizuoka (JP)

(21) Appl. No.: 14/483,365

(22) Filed: Sep. 11, 2014

(51) Int. Cl. G03G 15/20

(52) U.S. Cl. CPC G03G 15/2028

(57) ABSTRACT

In accordance with one embodiment, an image forming apparatus comprises an image forming section configured to be capable of forming an image with erasable coloring agent; a storage section configured to include a first and a second cassettes capable of storing an image receiving medium; an erasing section configured to heat the image receiving medium on which an image is formed with the erasable coloring agent at a pre-set temperature to erase the image; and a conveyance section configured to convey the image receiving medium stacked in the first cassette through a first conveyance path which passes through the image forming section and the erasing section, and convey the image receiving medium the image on which is erased by the erasing section to the second cassette of the storage section through a second conveyance path.

### FIELD

Embodiment described herein relate to an image forming apparatus which can form an image with erasable coloring agent and inerasable coloring agent, and furthermore, can erase an image formed with erasable coloring agent on an image receiving medium (paper) fed from a paper feed source and then automatically convey the image receiving medium (paper) to the paper feed source.

### BACKGROUND

Conventionally, there is an image forming apparatus capable of forming an image with erasable coloring agent and inerasable coloring agent. In a case of reusing the paper on which an image is formed with the erasable coloring agent, the paper to be reused is aligned and stacked in a paper feed cassette by a user. The paper to be reused is taken out of the paper feed cassette and conveyed to an erasing device (fixing device) to be heated to erase the image.

However, the user has to align the paper to be reused and then stack the paper to be reused in the paper feed cassette, which is troublesome.

### BRIEF DESCRIPTION OF THE DRAWINGS

FIG. 1 is a diagram illustrating the constitution of an image forming apparatus according to one embodiment;

FIG. 2 is a diagram illustrating the constitution of an enlarged fixing device (erasing section) according to the embodiment;

FIG. 3 is a perspective view illustrating one example of a cassette of a storage section according to the embodiment;

FIG. 4 is a diagram illustrating the constitution of a conveyance section for conveying paper on conveyance paths A and B and a reversal conveyance path C according to the embodiment;

FIG. 5 is a diagram illustrating another constitution of the conveyance section according to the embodiment;

FIG. 6 is a block diagram illustrating a control system of the image forming apparatus according to the embodiment;

FIG. 7 is an illustration diagram illustrating the flow of the paper in a case of forming images on single side and both sides of the paper in the embodiment;

FIG. 8 is an illustration diagram illustrating the flow of the paper in a case of conveying the paper to be reused in the embodiment;

FIG. 9 is an illustration diagram illustrating the flow of the paper in a case of conveying the paper to be reused from an option cassette in the embodiment;

FIG. 10 is a diagram illustrating the constitution of a paper conveyance section in a second embodiment;

FIG. 11 is an illustration diagram illustrating the flow of the paper in a case of conveying the paper to be reused in the second embodiment; and

FIG. 12 is an illustration diagram illustrating the flow of the paper in a case of conveying the paper to be reused from an option cassette in the second embodiment.

### DETAILED DESCRIPTION

In accordance with one embodiment, an image forming apparatus comprises an image forming section configured to be capable of forming an image with erasable coloring agent; a storage section configured to include a first and a second cassette capable of storing an image receiving medium; an erasing section configured to heat the image receiving medium on which an image is formed with the erasable coloring agent at a pre-set temperature to erase the image; and a conveyance section configured to convey the image receiving medium stacked in the first cassette through a first conveyance path which passes through the image forming section and the erasing section, and convey the image receiving medium the image on which is erased by the erasing section to the second cassette of the storage section through a second conveyance path.

Hereinafter, the image forming apparatus according to the embodiment is described in detail with reference to the accompanying drawings. In addition, the same components in each drawing are applied with the same reference numerals.

### A First Embodiment

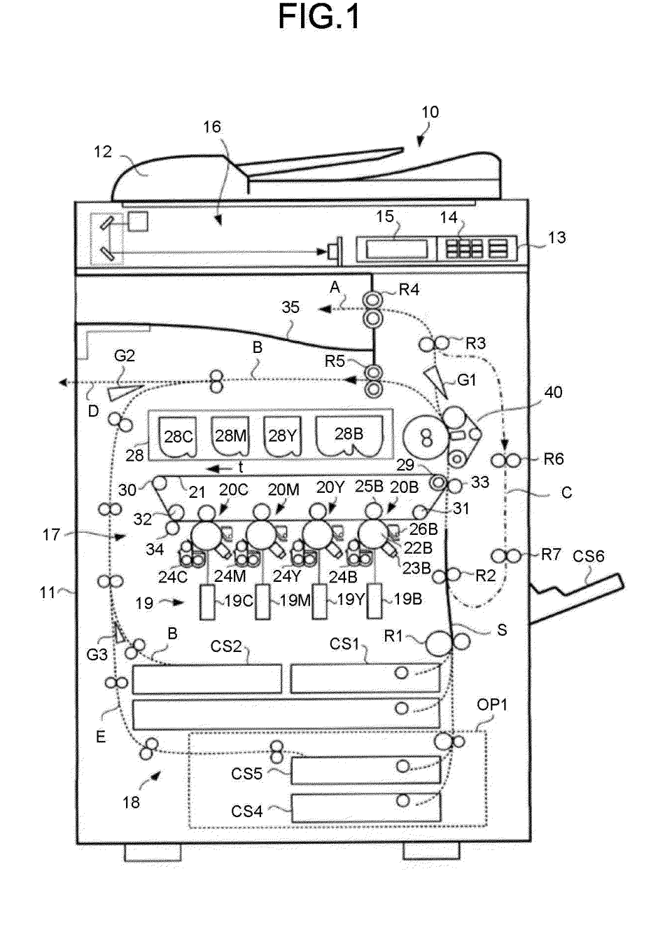

FIG. 1 is a diagram illustrating the constitution of the image forming apparatus according to the embodiment. In FIG. 1, an image forming apparatus 10 is, for example, an electrophotographic type, electrostatic recording type or magnetic recording type multi-function peripheral (MFP). In addition to the MET, a printer, a copier and the like may also be used as the image forming apparatus 10, however, in the following description, the MFP is described as an example.

At the upper portion of a main body 11 of a MFP 10 is arranged a document table above which an ADF (Automatic Document Feeder) 12 is arranged in an openable and closable manner. Further, an operation panel 13 is arranged at the upper portion of the main body 11. The operation panel 13 includes various operation keys 14 and a touch panel type display section 15. The operation keys 14 include a numeric key, a start key and the like.

A scanner section 16, which is arranged under the ADF 12 inside the main body 11, reads a document fed by the ADF 12 or a document placed on the document table to generate image data. A printer section 17 is arranged at the center part of the main body 11, and a storage section 18 including a plurality of cassettes is arranged at the lower part of the main body 11 to store paper of various sizes.

The printer section 17 consisting of a photoconductive drum, a scanning head and the like processes image data read by the scanner section 16 and image data created by, for example, a PC (Personal Computer), and fixes an image on paper serving as an image receiving medium. The paper on which an image is fixed by the printer section 17 is discharged to a paper discharge section 35.

The printer section 17, which is, for example, a tandem-form color laser printer, exposes the photoconductor with the light from a scanning head 19 to generate an image. The printer section 17 includes cyan (C), magenta (M, yellow (Y) and blue (B) image forming sections 20C, 20M, 20Y and 20B. The image forming sections 20C, 20M, 20Y and 20B are arranged in parallel at the lower side of a transfer belt 21, which is capable of moving in a direction indicated by an arrow t, along a direction from the upstream side to the downstream side. The scanning head 19 includes a plurality of scanning heads 19C, 19M, 19Y and 19B corresponding to the image forming sections 200, 20M, 20Y and 20B. The scanning heads 19C, 19M, 19Y and 19B are respectively provided with LED elements serving as light sources arranged in a line at equal intervals in a horizontal scanning direction.

In the present embodiment, for example, the image forming section 20B forms an image with erasable blue coloring agent (hereinafter referred to as B toner as needed). Further, the image forming section 20C forms an image with inerasable cyan coloring agent (hereinafter referred to as C toner as needed), the image forming section 20M forms an image with inerasable magenta coloring agent (hereinafter referred to as M toner as needed), and the image forming section 20Y forms an image with inerasable yellow coloring agent (hereinafter referred to as Y toner as needed). Further, a monochrome (black) image is formed by the image forming sections 20C, 20M and 20Y by mixing the cyan, magenta, yellow colors.

As the image forming sections 20C, 20M, 20Y and 20B are structurally identical to each other, the image forming section 20B is described as a representative example. The image forming section 20B is provided with a photoconductive drum 22B around which an electrostatic charger 23B, a developing device 24B, a transfer roller 25B, a cleaner 26B and the like are arranged. A toner cartridge 28 is arranged above the image forming sections 20C, 20M, 20Y and 20B to supply toner for the developing devices 24C, 24M, 24Y and 24B. The toner cartridge 28 consists of cyan (C), magenta (M), yellow (Y) and blue (B) toner cartridges 28C, 28M, 28Y and 28B which are adjacent to each other.

However, the toner stored in the developing device 24B of the image forming section 20B is erasable blue toner, while the toner stored in the developing devices 24C, 24M and 24Y is inerasable toner.

The image formed with the erasable B toner stored in the developing device 24B can cause a reversible color generation/erasing reaction which erases the color if the temperature is above a specific temperature and generates color if the temperature is below a specific color recovery temperature. As the coloring agent used in the erasable toner, any coloring agent that can be erased by raising the temperature by heating and can recover the color if the temperature is below a specific temperature can be used. For example, the leuco dye is generally used as well-known coloring agent, and the coloring agent is selected which is formed by combining the leuco dye with color developing agent, color erasing agent, color changing temperature adjusting agent and the like properly and can erase the color if the temperature is above a certain temperature and recover the color if the temperature is below a certain temperature.

From a viewpoint of heat resistance and abrasion resistance, for example, a semi-conductive polyimide is used as the transfer belt 21 which moves cyclically. The transfer belt 21 is stretched by a drive roller 29 and driven rollers 30, 31 and 32. The transfer belt 21 faces the photoconductive drum 22B and can be contacted with the photoconductive drum 22B. At the position where the transfer belt 21 faces the photoconductive drum 22B, a primary transfer voltage is applied by the transfer roller 25B to primarily transfer a toner image on the photoconductive drum 22B to the transfer belt 21.

Further, a secondary transfer roller 33 is arranged opposite to the drive roller 29. When paper S passes through the space between the drive roller 29 and the secondary transfer roller 33, a secondary transfer voltage is applied by the secondary transfer roller 33 to secondarily transfer the toner image on the transfer belt 21 to the paper S. A belt cleaner 34 is arranged nearby the driven roller 32 of the transfer belt 21.

Light is emitted from the scanning head 19B to the exposure position of the photoconductive drum 22B to form an electrostatic latent image on the surface of the photoconductive drum 22B. The electrostatic charger 23B uniformly charges the entire surface of the photoconductive drum 22B. The developing device 24B supplies two-component developing agent including toner and carrier for the photoconductive drum 22B through a developing roller to form a toner image on the photoconductive drum 22B. After the toner image on the photoconductive drum 22B is primarily transferred to the transfer belt 21, the cleaner 26B removes the toner left on the surface of the photoconductive drum 22B.

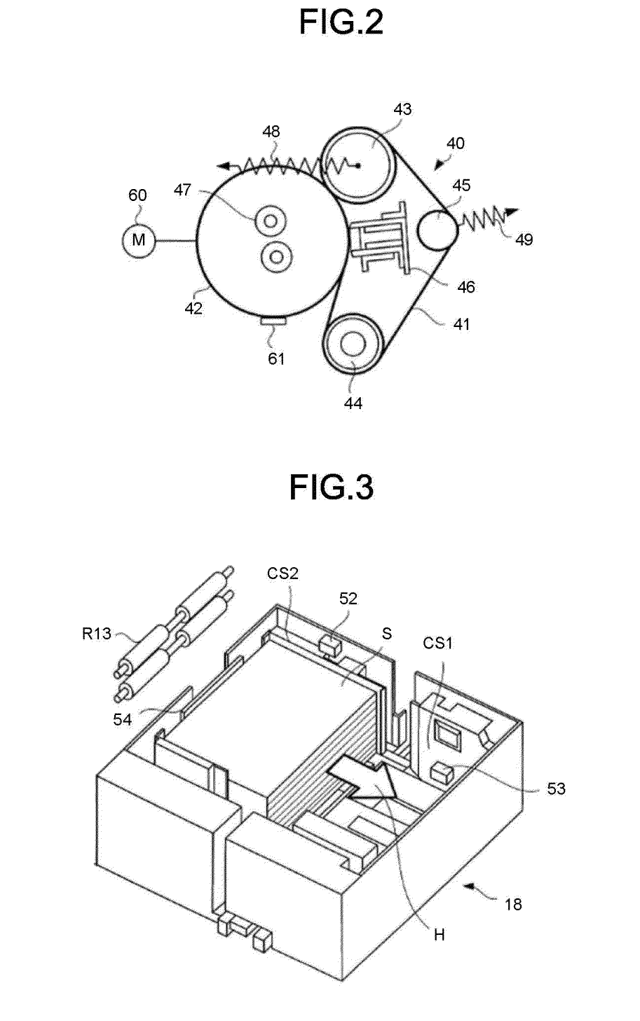

Further, a conveyance roller R1 and a register roller R2 for conveying the paper S in the paper feed cassette 18 are arranged along the conveyance path from the paper feed cassette 18 to the secondary transfer roller 33, and a fixing device 40 is arranged at the downstream side of the secondary transfer roller 33. The paper S to which the toner image is secondarily transferred by the secondary transfer roller 33 is conveyed to the fixing device 40 and heated by the fixing device 40, in this way, the toner image is fixed on the paper S. The fixing device 40 is described in detail in FIG. 2.

Conveyance rollers R3 and R4 for discharging the paper S to the paper discharge section 35 are arranged at the downstream side of the fixing device 40. The conveyance roller R3 is capable of reversing paper, thus, it is also referred to as a reversing roller. The paper S is conveyed through a first conveyance path A from the conveyance roller R1 via the register roller R2 to the secondary transfer roller 33, and from the secondary transfer roller 33 to the fixing device 40 and further to the paper discharge section 35 through the conveyance rollers R3 and R4.

Further, a second conveyance path B is arranged to return the paper S from the fixing device 40 to the storage section 18 (paper feed source) through a conveyance roller R5. The conveyance path B which will be described in detail later is a dedicated conveyance path for returning the paper S from the fixing device 40 to the storage section 18 (paper feed source). Further, a reversal conveyance path C used when duplex printing is carried out is arranged. The reversal conveyance path C includes a plurality of conveyance rollers R6 and R7. The paper S is temporarily conveyed from the reversing roller R3 towards the paper discharge section 35, and then switched back and conveyed to the reversal conveyance path C through the backward rotation of the reversing roller R3.

On the reversal conveyance path C, the paper S is guided from the register roller R2 towards the direction of the secondary transfer roller 33 through the rotation of the conveyance rollers R6 and R7. Further, the paper S passing through the fixing device 40 is guided to the paper discharge section 35 (conveyance path A) or the conveyance path B through a gate G1 used for distribution.

The operations of the image forming apparatus 10 are briefly described. If image information is input from the scanner section 16 or a personal computer terminal (PC) and the like, images are formed with C toner, M toner, Y toner and B toner by each of the image forming sections 20C-20B. In a case of forming a color image, the magenta (M) and the yellow (Y) toner images are multiple-transferred at the same position where the cyan (C) toner image is formed on the transfer belt 21 to obtain a full color toner image.

The full color toner image on the transfer belt 21 is secondarily transferred to the paper S by the secondary transfer roller 33. The paper S is fed from the paper feed cassette 18 to the position of the secondary transfer roller 33. The paper S to which the toner image is secondarily transferred is conveyed to the fixing device 40 to fix the toner image on the paper S. On the other hand, after the secondary transfer is completed, the toner left on the transfer belt 21 is cleaned by the belt cleaner 34.

Further, for example, in a case of forming an image such as monochrome character information, the printer section 17 can use the image forming sections 20C, 20M and 20Y to develop the image to mix the cyan, the magenta and the yellow colors to form the monochrome image.

In a case of forming an image with erasable toner, only the image forming section 20B is used to develop the image.

The service life of the image forming sections 20C, 20M, 20Y and 20B depends on the operation time, thus, in a case of forming an image with the erasable toner, it is preferred that the printer section 17 does not operate other image forming sections 20C, 20M and 20Y except the image forming section 20B.

In a case of forming a color image or a monochrome image through the image forming sections 20C, 20M and 20Y, the printer section 17 separates the transfer belt 21 from the transfer roller 25B and the photoconductive drum 22B through a moving mechanism, and contacts the transfer belt 21 with other transfer rollers 25C, 25M and 25Y and photoconductive drums 22C, 22M and 22Y.

In a case of forming an image with the erasable B toner, if the transfer belt 21 is rotated in a state of being contacted with the photoconductive drums 22C, 22M and 22Y, the transfer belt 21 and the photoconductive drums 22C, 22M and 22Y are worn and damaged. Thus, it is better to separate the transfer belt 21 from the photoconductive drums 22C, 22M and 22Y through the moving mechanism mentioned above.

Next, the fixing device 40 is described. FIG. 2 is a diagram illustrating the constitution of the enlarged fixing device 40. The fixing device 40 consists of a fixing belt 41, a heating roller 42, a pressing roller 43, an auxiliary roller 44 and a tension roller 45. The auxiliary roller 44 is arranged at the entering side of the paper S, and the fixing belt 41 stretched by the pressing roller 43, the auxiliary roller 44 and the tension roller 45 is wound on part of the heating roller 42.

Further, the fixing device 40 includes a pad member 46, a halogen lamp 47 for heating, a pressing spring 48, and a spring 49 for applying tension. The pressing roller 43 presses, across the fixing belt 41, against the heating roller 42 at a given pressure through the pressing spring 48. The tension roller 45 applies a given tension to the fixing belt 41 through the spring 49. The heating roller 42 is rotated under the driving force transmitted from a DC brushless motor 60 fixed in the printer section 17.

The fixing belt 41, the pressing roller 43, the auxiliary roller 44 and the tension roller 45 are driven to rotate under the rotation of the heating roller 42. Further, the fixing belt 41 is pressed against the heating roller 42 by the pad member 46. The heating roller 42 is formed by coating, for example, PTFE (Polytetrafluoroethylene) on the surface of an iron hollow cylinder.

The heating roller 42, which includes the halogen lamp 47 inside, heats the heating roller 42 from inside through radiant heat. Further, a thermistor 61 for detecting temperature is arranged to be contacted with the surface of the heating roller 42. The halogen lamp 47 is turned on or turned off based on the output of the thermistor 61 to control the surface of the heating roller 42 to a given temperature.

When the paper S passes through a nip from a point where the fixing belt 41 starts to contact with the heating roller 42 to a point where the pressing roller 43 presses against the heating roller 42, the toner on the paper S is fixed by heating and pressure.

In addition, the fixing device 40 functions as an erasing section by carrying out heating at a temperature higher than the temperature (fixing temperature) used when fixing the toner image on the paper S. That is, if the paper (paper to be reused) on which the image is formed with the erasable B toner is conveyed to the fixing device 40, and if the temperature of the fixing device 40 is set to a specific temperature higher than the fixing temperature, the image formed with the erasable B toner is erased. In the following description, the fixing device 40 is referred to as the erasing section as needed.

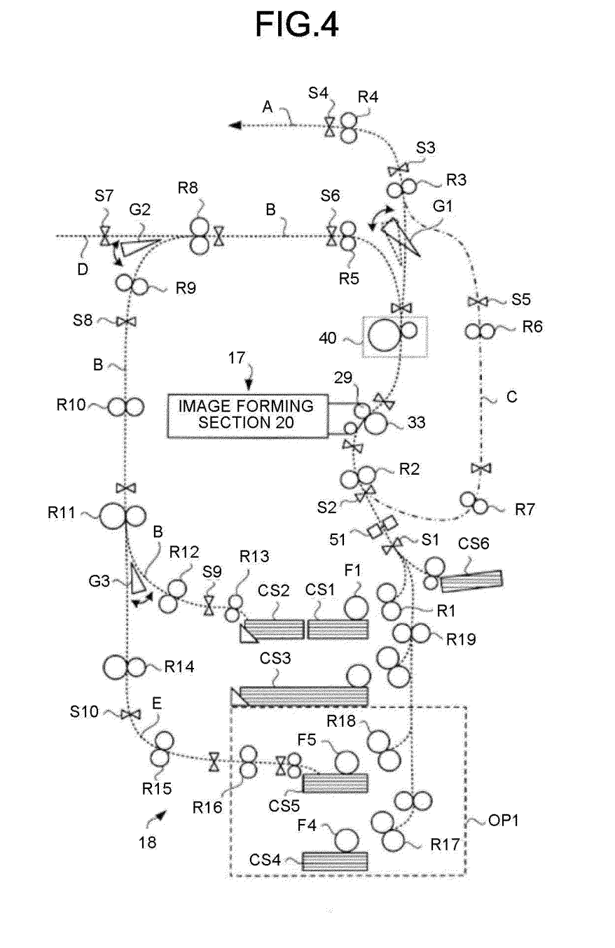

FIG. 3 is a perspective view illustrating one example of a cassette arranged at the upper part of the storage section 18. The storage section 18 is provided with a first cassette CS1 and a second cassette CS2 arranged in parallel, and the paper S conveyed by the conveyance roller R13 (FIG. 4) through the conveyance path B is stacked in the cassette CS2 in sequence. The cassette CS2 is provided with a full-state detection sensor 52 and the cassette CS1 is provided with an empty-state detection sensor 53. In a case where the cassette CS2 is full of the stacked paper and the cassette CS1 is empty, the stacked paper is slide in a direction indicated by an arrow H and moved to the cassette CS1 by a slide plate 54 serving as a moving member. The slide plate 54 returns to the original position after moving the stacked paper S to the cassette CS1.

FIG. 4 is a diagram illustrating the constitution for conveying the paper S on the conveyance paths A and B and the reversal conveyance path C. In addition, in the following description, the image forming sections 20C, 20M, 20Y and 20B are referred to as an image forming section 20 collectively.

In FIG. 4, the storage section 18 is provided with a plurality of cassettes CS1, CS2 and CS3, in which the cassettes CS1 and CS2 are structurally identical to those shown in FIG. 3. Further, in FIG. 4, an option cassette OP1 including a first cassette CS4 and a second cassette CS5 arranged vertically can be connected. Furthermore, a manual feeding cassette CS6 is arranged.

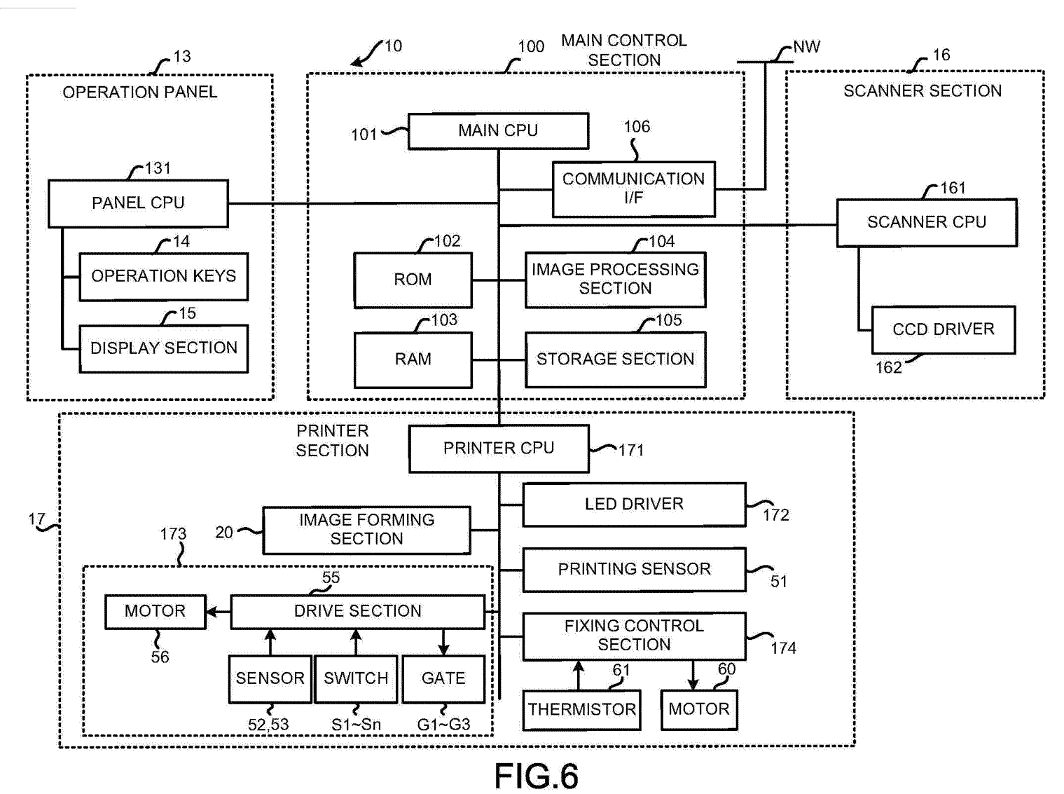

Only the image forming section 20, the drive roller 29 and the secondary transfer roller 33 in the printer section 17 and the fixing device 40 are shown in FIG. 4. Further, a printing sensor 51 constituting an image reading section is arranged at the upstream side of the register roller R2 to read the image information printed on the paper S. The printing sensor 51 can read the images formed on both sides of the paper S and store the read information in a storage section 105 (FIG. 6), and read the erased image information from the storage section 105 and use it in the image formation processing again. Moreover, in a case where there are residual images left on the paper S after the erasing processing, the printing sensor 51 can be used to read the erasing residual images to determine whether or not there is erasing residual.

Each of the conveyance paths A, B and C is provided with a plurality of conveyance rollers R1-R19 including the register roller R2 and switches S1-Sn for detecting the conveyance of the paper S. In addition, reference numerals (S1-S10) are applied only to main switches in the plurality of switches S1-Sn in FIG. 4.

The conveyance of the paper S is detected by the switches S1-Sn, in this way, the conveyance rollers R1-R19 are rotated in sequence to convey the paper S to the any of the conveyance paths A, B and C. Further, a plurality of gates G1, G2 and G3 are arranged to distribute and convey the paper S to the conveyance paths A, B or C. The conveyance path B serves as the second conveyance path for returning the paper S from the fixing device 40 to the storage section 18 (paper feed source), however, the conveyance path B is provided with the gates G2 and G3 which can distribute the paper S to a conveyance path D or a conveyance path E. The conveyance path D conveys the paper S to a finisher (not shown) connected with the rear part of the image forming apparatus 10. The conveyance path E conveys the paper S to the option cassette OP1.

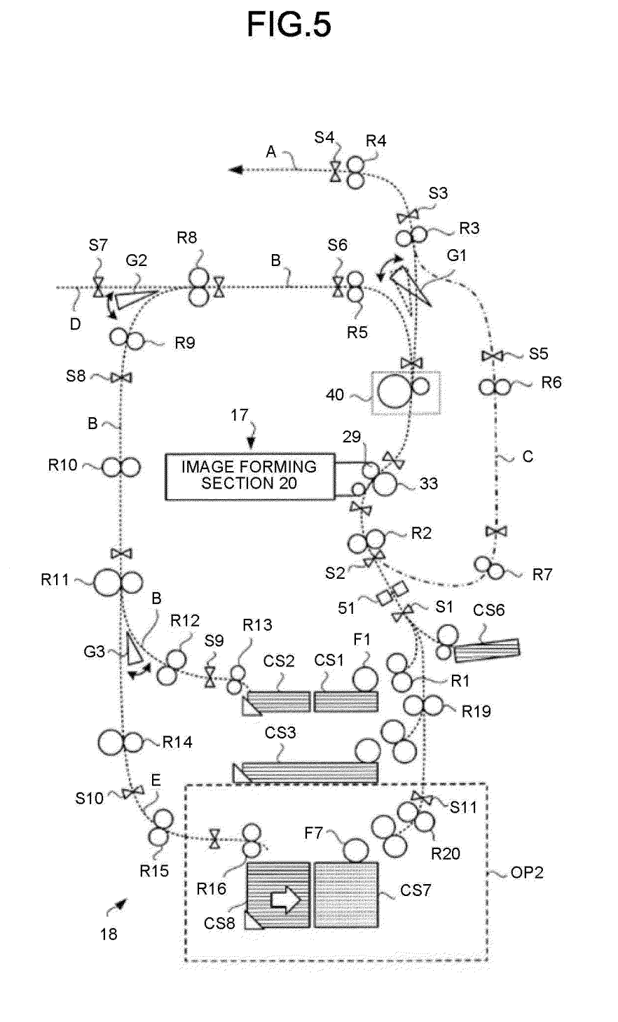

FIG. 5 is a diagram illustrating another constitution for conveying the paper S on the conveyance paths A and B and the reversal conveyance path C, in which another option cassette OP2 is connected with the storage section 18. The option cassette OP2 including cassettes CS7 and CS8 consists of a paper feed roller F7, a conveyance roller R20 and a switch S11.

The option cassette OP2, which is structurally identical to the storage section 18 shown in FIG. 3, includes the first cassette CS7 and the second cassette CS8 arranged in parallel. The paper stacked in the cassette CS7 is conveyed towards the image forming section 20, and the paper S conveyed via the conveyance path B by the conveyance roller R16 is stacked in the cassette CS8 in sequence. The cassette CS8 is provided with a full-state detection sensor and the cassette CS7 is provided with an empty-state detection sensor. In a case where the cassette CS8 is full of stacked paper and the cassette CS7 is empty, the paper stacked in the cassette CS8 is moved to the cassette CS7.

FIG. 6 is a block diagram illustrating the constitution of the control system of the image forming apparatus (MFP) 10 according to the embodiment. In FIG. 6, the MFP10 includes a main control section 100, the operation panel 13, the scanner section 16 and the printer section 17. The control system of the MFP10 includes a plurality of CPUs, that is, a main CPU 101 in the main control section 100, a panel CPU 131 of the operation panel 13, a scanner CPU 161 of the scanner section 16 and a printer CPU 171 of the printer section 17, and carries out communication between each CPU.

The main control section 100 includes the main CPU 101, a ROM 102, a RAM 103, an image processing section 104, a storage section 105 such as an HDD, and a communication interface (I/F) 106 and the like. The main CPU 101 controls the entire operations of the MFP10 and controls the ADF12. The ROM 102 stores a control program and the like. The RAM 103 stores data temporarily.

The image processing section 104 processes the image data read by the scanner section 16 and the image data from a PC and the like, and carries out various image processing, for example, image conversion processing for enlarging/reducing the image.

Further, the storage section 105 compresses and stores the image data read by the scanner section 16 and the image data (document data, drawn image data and the like) from the PC. The image data stored in the storage section 105 is input to the image processing section 104, subjected to various image processing and then printed on paper by the printer section 17. The communication interface 106 connected with a network NW carries out communication with an external machine (for example, a PC and the like) through the network NW.

The operation panel 13 includes the panel CPU 131 connected with the main CPU 101, various operation keys 14 and the display section 15 including liquid crystal and the like. The operation keys 14 include a numeric key for instructing the number of printings and the like. The display section 15 has a touch panel function for inputting instructions such as the paper size, printing magnification, simplex printing and duplex printing. Further, a printing mode such as monochrome printing (monochrome mode), full color printing (full color mode), printing with erasable toner (reuse mode) and the like can be designated by touching the display section 15.

In addition to the scanner CPU 161, the scanner section 16 further includes a CCD driver 162 for driving the image sensor. The CCD driver 162 drives the image sensor to read the image of the document and convert the image into image data.

The printer section 17 includes the printer CPU 171, an LED driver 172, the image forming section 20, the printing sensor 51, a conveyance section 173 and a fixing control section 174, and carries out printing on paper through the cooperation with the main CPU 101 of the main control section 100.

The LED driver 172 drives the LED elements of the scanning head 19. The conveyance section 173 includes a drive section 55 which is connected with a motor 56 for driving and rotating the switches (S1-Sn), the gates (G1-G3), the full-state detection sensor 52, the empty-state detection sensor 53, the conveyance rollers (R1-R20) and the paper feed rollers (F1-F7). In fact, the number of the motors 56 is more than one.

Under the control of the printer CPU 171 serving as a control section, the drive section 55 drives the motor 56 to rotate the conveyance rollers (R1-R20) and the paper feed rollers (F1-F7), control the gates (G1-G3) to control the conveyance direction of the paper S, and control the conveying-in/discharge of the paper S to the cassette of the storage section 18.

The fixing control section 174 is connected with the motor 60 and the thermistor 61. The fixing control section 174 controls the rotation of the heating roller 42 of the fixing device 40 and the temperature of the heating roller 42.

Further, the printer CPU 171 controls the image forming section 20. The control on the image forming section 20 includes the control on the electrostatic charger, the developing device, the transfer device and the like. The printer CPU 171 selects, according to the image forming mode designated from the operation panel 13, the image forming section supposed to operate from the image forming sections 20C, 20M, 20Y and 20B, and operates the selected image forming section.

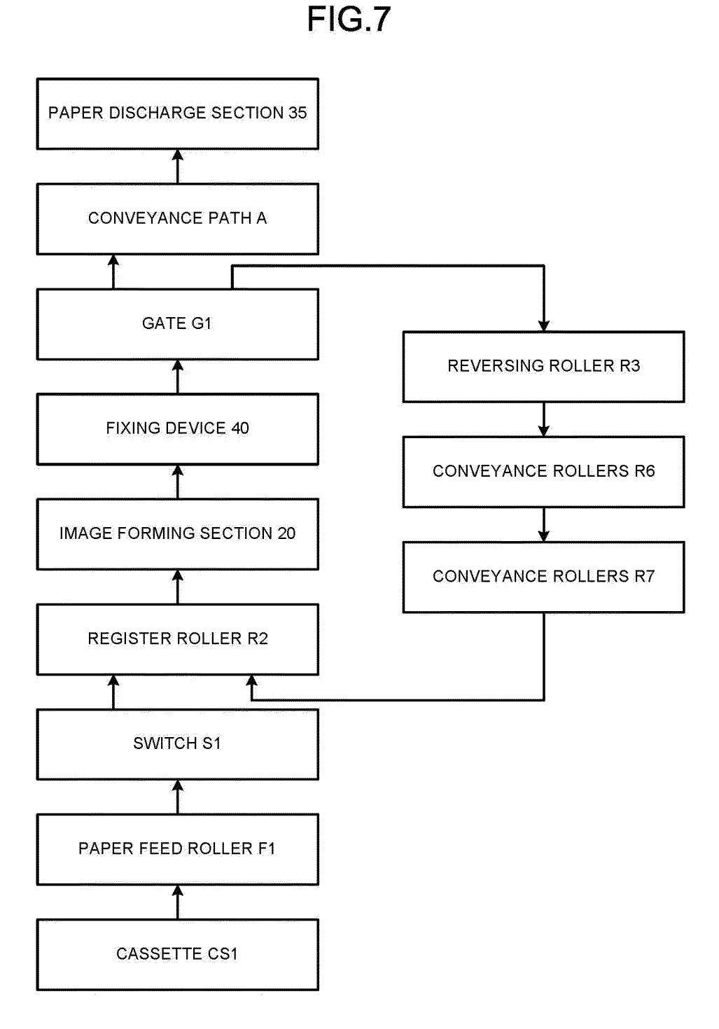

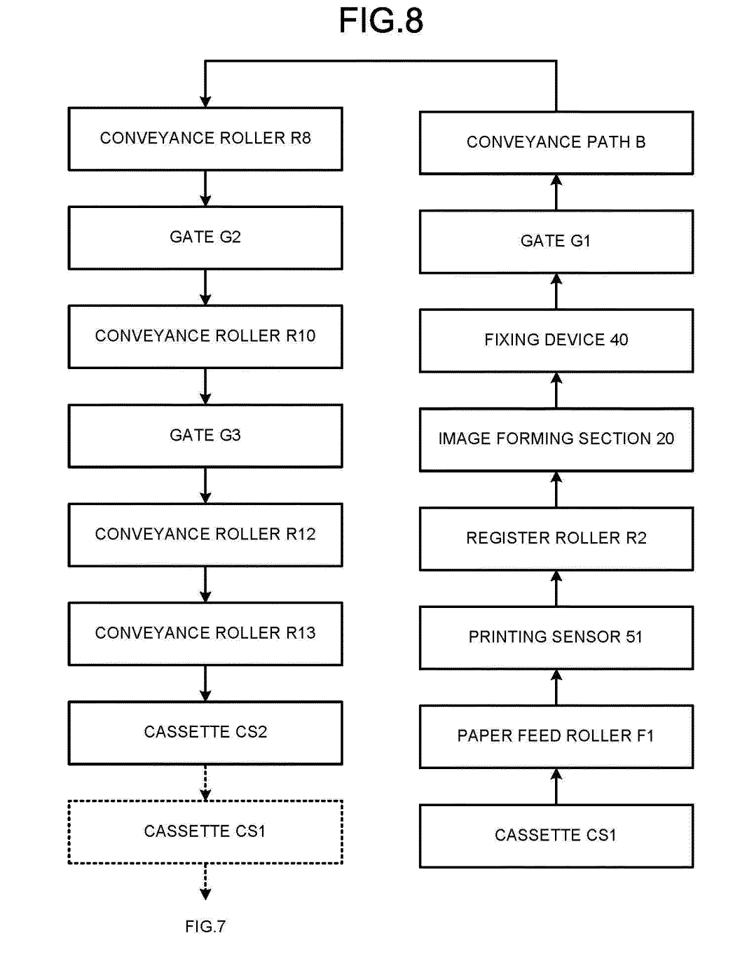

Next, the conveyance of the paper S in the embodiment is described with reference to FIG. 7-FIG. 9. In FIG. 7-FIG. 9, though only the main components for the conveyance of the paper S are shown, in fact, the paper S is conveyed through each component shown in FIG. 4 or FIG. 5.

FIG. 7 is a diagram illustrating the conveyance of the paper S in a case of forming images on single side and both sides of the paper S. In a case of forming an image on the paper S, the paper S is fed by the paper feed roller F1 from the cassette CS1 at the lower part of FIG. 7. If the paper is detected by the switch S1, the register roller R2 is rotated to convey the paper S to the image forming section 20, and the image forming section 20 forms an image on the paper.

The paper S on which an image is formed by the image forming section 20 is conveyed to the fixing device 40. The fixing device 40 heats the paper S at the fixing temperature to fix the toner on the paper S. After the fixing processing, the paper S is conveyed to the gate G1. In a case where the front end of the gate G1 is directed downwards as shown by dotted lines in FIG. 4, the paper S is conveyed to the upper part of the conveyance path A and then discharged to the paper discharge section 35.

Further, in a case of duplex printing, the reversing roller R3 is rotated reversely to switch back the paper S towards the reversal conveyance path C. The paper S is conveyed to the register roller R2 through the conveyance rollers R6 and R7 of the reversal conveyance path C, and then the image forming section 20 forms an image on the back side of the paper S. After the image is fixed by the fixing device 40, the paper S is conveyed to the conveyance path A through the gate G1 and discharged to the paper discharge section 35.

As to the image formation in the image forming section 20, a monochrome image, a full color image or an image based on erasable B toner can be formed. A user can operate the operation panel 13 to select the mode to form an image.

FIG. 8 is an illustration diagram illustrating the flow of the paper in a case of conveying the paper S (the paper to be reused) on which an image is formed with the erasable toner. The paper S to be reused is fed by the paper feed roller Fl from the cassette CS1 at the lower right of FIG. 8. The image formed on the paper S is read by the printing sensor 51, and then the paper S is conveyed by the register roller R2 via the image forming section 20 to the fixing device 40 (erasing section). At this time, the image forming section 20 passes the paper S through the secondary transfer roller 33 without carrying out image forming processing. The paper S conveyed to the fixing device 40 is heated at a temperature higher than the fixing temperature, in this way, the image formed on the paper S is erased.

After the image is erased, the paper S is conveyed to the gate G1. In a case where the front end of the gate G1 is rotated anticlockwise to a position shown by the solid line in FIG. 4, the paper S is conveyed to the conveyance path B. Then the paper S is conveyed by the conveyance roller R8 in a downward direction in FIG. 8 through the gate G2. The paper S is conveyed by the conveyance rollers R10 and R11, and is conveyed to the direction of the cassette CS2 through the gate G3. The paper S is conveyed by the conveyance rollers R12 and R13 and stacked in the cassette CS2.

In the aforementioned procedure, the paper S the image on which is erased is stacked in the cassette CS2 in sequence. On the other hand, in a case where the paper stacked in the cassette CS1 runs out and the cassette CS1 becomes empty, the paper S stacked in the cassette CS2 is moved to the cassette CS1. As to the structure of the cassettes CS1 and CS2, as shown in FIG. 3, the paper S in the cassette CS2 can be moved to the cassette CS1 by sliding the slide plate 54.

Thus, the paper the image on which is erased by the fixing device 40 is stacked in the cassette CS1. In a case of reusing the paper in the cassette CS1 to form a new image, the image may be formed on single side or both sides of the paper according to the procedure shown in FIG. 7.

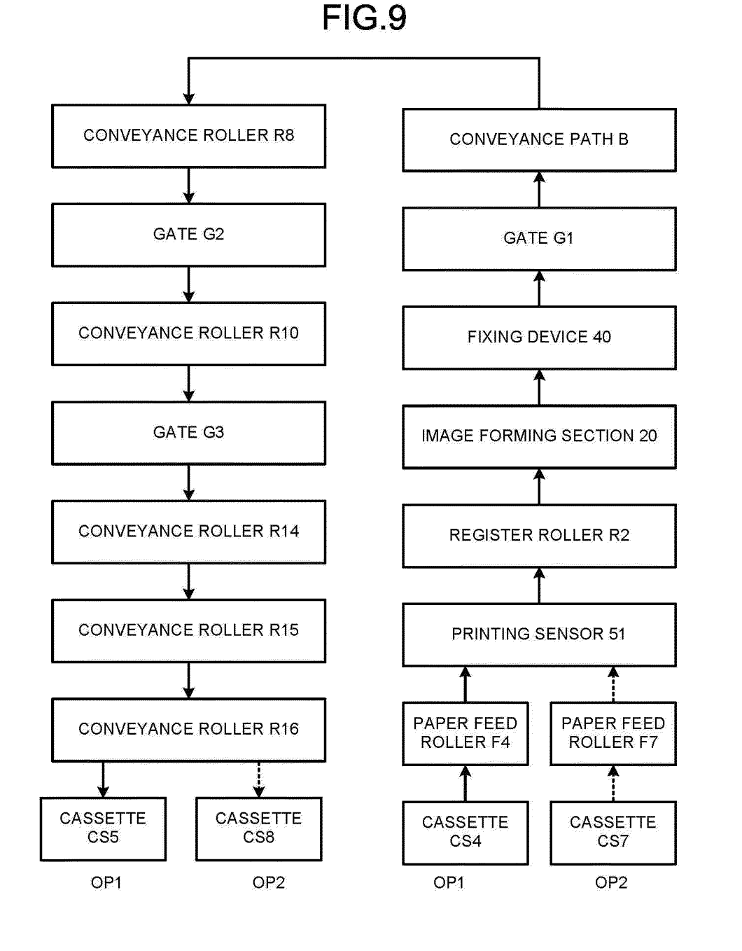

FIG. 9 is an illustration diagram illustrating the flow of the paper in a case of conveying the paper S (the paper to be reused), on which an image is formed with the erasable toner, stacked in the option cassette OP1 shown in FIG. 4 or the option cassette OP2 shown in FIG. 5 from the option cassette OP1 (or the OP2).

The paper S on which an image is formed with the erasable toner is fed by the paper feed roller F4 from the cassette CS4 of the option cassette OP1 (FIG. 4) at the lower right of FIG. 9. Alternatively, the paper S is fed by the paper feed roller F7 of the cassette CS7 of the option cassette OP2 (FIG. 5)

The image formed on the paper S is read by the printing sensor 51. Then the paper S is conveyed by the register roller R2 via the image forming section 20 to the fixing device 40. At this time, the image forming section 20 passes the paper S through the secondary transfer roller 33 without carrying our image forming processing. The paper S conveyed to the fixing device 40 (erasing section) is heated at a temperature higher than the fixing temperature, in this way, the image formed on the paper S is erased.

After the image is erased, the paper S is conveyed to the gate G1. In a case where the front end of the gate G1 is rotated anticlockwise to a position shown by the solid line in FIG. 4, the paper S is conveyed to the conveyance path B. Then the paper S is conveyed by the conveyance roller R8 in a downward direction in FIG. 9 through the gate G2. The paper S is conveyed by the conveyance rollers R10 and R11, and then conveyed to the direction of the conveyance roller R14 and the conveyance roller R15 through the gate G3. In the example shown in FIG. 4, the paper S conveyed to the option cassette OP1 is stacked in the cassette CS5 through the conveyance roller R16. Further, in the example shown in FIG. 5, the paper S conveyed to the option cassette OP2 is stacked in the cassette CS8 through the conveyance roller R16.

In the aforementioned procedure, the paper S the image on which is erased is stacked in the cassette CS5 or the cassette CS8 in sequence. Further, when the paper stacked in the cassette CS7 runs out and the cassette CS7 becomes empty, the paper stacked in the cassette CS8 can be slide and moved to the cassette CS7.

In a case of reusing the paper in the cassette CS5 to form a new image, the paper in the cassette CS5 can be taken out by the paper feed roller F5 and conveyed by the conveyance roller R18, and then subjected to the image forming processing on single side or both sides thereof through the same procedure as shown in FIG. 7.

Further, in a case of reusing the paper moved to the cassette CS7 to form a new image, the paper in the cassette CS7 can be taken out by the paper feed roller F7 and conveyed by the conveyance roller R20, and then subjected to the image forming processing on single side or both sides thereof through the same procedure as shown in FIG. 7.

In the first embodiment, the second conveyance path B for returning the discharged paper passing through the fixing device 40 to the paper feed source (storage section 18) is arranged. Thus, the paper the image on which is erased can be conveyed to the paper feed source automatically.

The paper stacked in the cassette of the paper feed source can be detected by the full-state detection sensor, and the paper can be moved from the paper stacking cassette to the paper feed cassette to be fed. Thus, the paper to be reused can be set in the cassette automatically. Further, in a case of forming an image on the paper to be reused, there is no need to take trouble to supply new paper for the paper feed cassette, and the simplex printing or duplex printing can be carried out automatically and smoothly.

In a case of carrying out printing on the paper to be reused stacked in the cassette CS1 (or the cassette CS4 or CS7), a user operates the operation panel 13 to designate the printing mode and then carries out printing. In a case where there is image residual which is not erased left on the paper to be reused, the printing sensor 51 can detect the image residual, thus, the printing can be stopped temporarily to erase the image. The paper confirmed to have image residual which is not erased thereon is conveyed to the fixing device 40 to be heated at a high temperature to erase the image, and then conveyed to the paper feed source through the conveyance path B. Thus, when printing is started again, an image can be formed on the paper having no image residual.

### A Second Embodiment

Next, the second embodiment is described. In the second embodiment, the first conveyance path and the second conveyance path are shared for returning the paper S from the fixing device 40 to the storage section 18 (paper feed source), and the conveyance rollers, the register rollers, the paper feed rollers and the like are reversibly rotated (rotated forward or backward) to return the paper to the paper feed source.

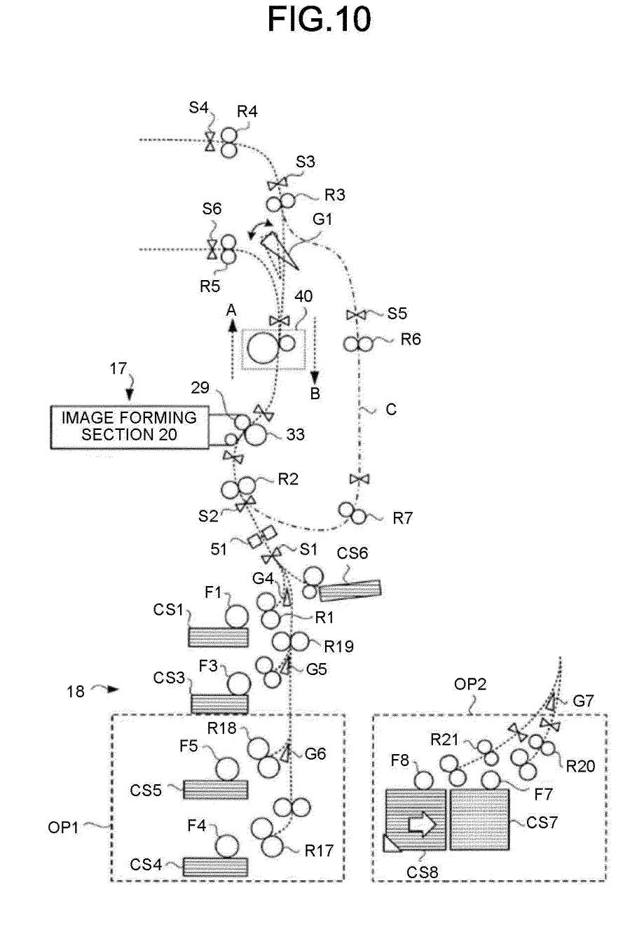

FIG. 10 is a diagram illustrating the constitution of the paper conveyance section of the paper S in the second embodiment. In FIG. 10, the storage section 18 is provided with an upper cassette CS1 and a lower cassette CS3. Only the image forming section 20, the drive roller 29 and the secondary transfer roller 33 of the printer section 17 and the fixing device 40 are shown. Further, the printing sensor 51 is arranged at the upstream side of the register roller R2 to read the image information printed on the paper S. The printing sensor 51 can read the image information formed on both sides of the paper S.

What is different from FIG. 4 is that in a case where the position of the paper feed source (storage section 18) is regarded as the upstream side, the paper S is conveyed to the downstream direction through the first conveyance path A which is from the paper feed source (storage section 18) and passes through the image forming section 20 and the fixing device 40, and the paper S the image on which is erased by the fixing device 40 is conveyed to the storage section 18 through the second conveyance path B the direction of which is opposite to the direction of the first conveyance path A. That is, the second conveyance path B conveys the paper S the image on which is erased to the upstream direction through the first conveyance path A and guides the paper S to the storage section 18. In addition, in a case of conveying the paper to the finisher (not shown), the paper is conveyed by the conveyance roller R5.

Each of the conveyance paths A and B is provided with a plurality of conveyance rollers R1-R4 including the register roller R2 and switches S1-S4 for detecting the conveyance of the paper S. The conveyance of the paper S is detected by the switches S1-S4, in this way, the conveyance rollers R1, the register roller R2 . . . are rotated in sequence to convey the paper S to the downstream direction along the conveyance path A. Further, the conveyance rollers R4 and R3, the register roller R2 . . . are rotated reversely to convey the paper S to the upstream direction along the conveyance path B. Moreover, the drive roller 29 and the secondary transfer roller 33 of the image forming section 20, and the heating roller 42 and the pressing roller 43 of the fixing device 40 can also be rotated reversely.

In addition, in FIG. 10, only the main switches in the plurality of switches S1-Sn are applied with the reference numerals (S1-S6). The gate G1 is arranged to distribute and convey the paper S to the conveyance paths A and B and the reversal conveyance path C.

Further, the storage section 18 may be connected with the option cassette OP1 including the cassettes CS4 and CS5 or the option cassette OP2 including the cassettes CS7 and CS8.

The option cassette OP1 includes the cassette CS4 and the cassette CS5 arranged vertically, in which the cassette CS4 includes the paper feed roller F4 and the conveyance roller R17, and the cassette CS5 includes the paper feed roller F5 and the conveyance roller R18.

The option cassette OP2 includes the cassettes CS7 and CS8 arranged in parallel, in which the cassette CS7 includes the paper feed roller F7 and the conveyance roller R20, and the cassette CS8 includes the paper feed roller F8 and the conveyance roller R21.

FIG. 10 shows an example in which the paper stacked in the cassette CS1 (or the cassette CS4 or CS7) is conveyed along the conveyance path A, and the paper conveyed through the conveyance path B is returned to the cassette CS3 (or the cassette CS5 or CS8). Further, gates G4, G5, G6 and G7 for guiding the paper returned through the conveyance path B to the cassettes CS3, CS5 or CS8 are arranged.

Though the control system in the second embodiment is structurally identical to that shown in FIG. 6, the drive section 55 of the conveyance section 173 reversely drives the motor 56 to control the rotation of the conveyance rollers, the paper feed rollers and the like, and control the gates (G1-G7) to control the conveyance direction of the paper S.

Next, the conveyance of the paper in the second embodiment is described. The conveyance of the paper S in a case of forming an image on single side and both sides of the paper S is the same as that described in FIG. 7, therefore, the description thereof is omitted herein.

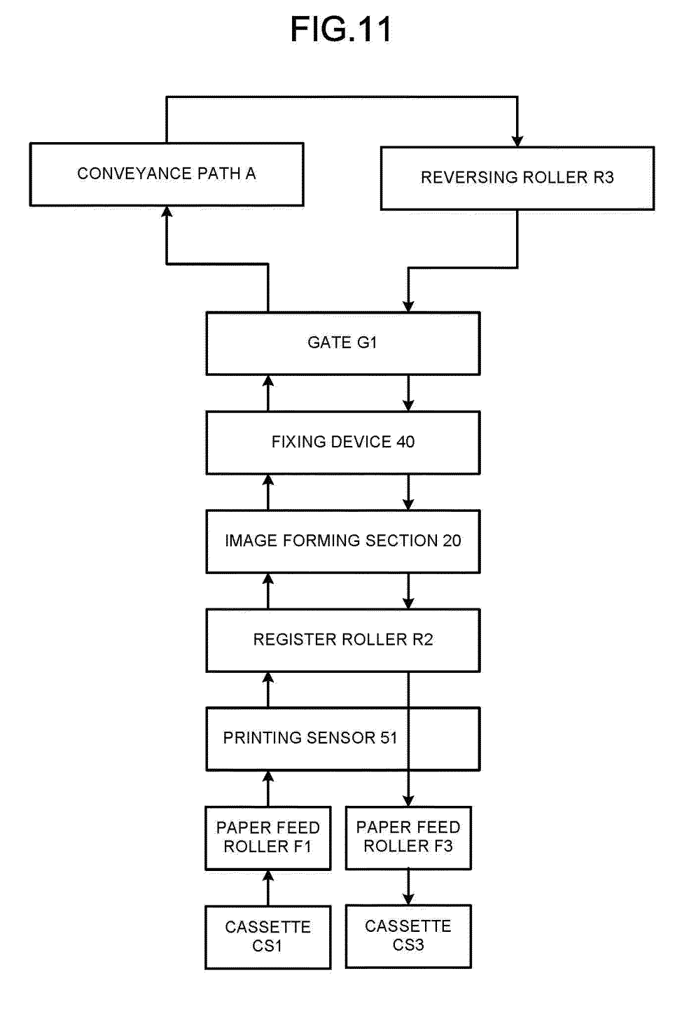

FIG. 11 is an illustration diagram illustrating the flow of the paper in a case of conveying the paper S (the paper to be reused) on which an image is formed with the erasable toner. The paper S on which an image is formed with the erasable toner is fed by the paper feed roller F1 from the first cassette CS1 at the lower left of FIG. 11. The image formed on the paper S is read by the printing sensor 51. Then the paper S is conveyed by the register roller R2 via the image forming section 20 to the fixing device 40. At this time, the image forming section 20 passes the paper S through the secondary transfer roller 33 without carrying out image forming processing. The paper S conveyed to the fixing device 40 (erasing section) is heated at a temperature higher than the fixing temperature, in this way, the image formed on the paper S is erased.

After the image is erased, the paper S is conveyed to the gate G1. In a case where the front end of the gate G1 is directed downwards as shown by the dotted lines in FIG. 10, the paper S is conveyed in the direction of the conveyance path A; however, after the paper passes through the fixing device 40, the conveyance of the paper is stopped and the reversing roller R3 is rotated reversely, and other conveyance rollers are also rotated in an opposite direction. Thus, the paper S is reversely conveyed towards the upstream side, and stacked in the cassette CS3 by the paper feed roller F3 of the cassette CS3 after passing through the switch gate G1, the fixing device 40, the image forming section 20 and the register roller R2. At this time, the paper is not read by the printing sensor 51. The gates G4 and G5 switch the stacking destination of the paper S to the cassette CS3.

In the aforementioned procedure, the paper S the image on which is erased is stacked in the cassette CS3 in sequence.

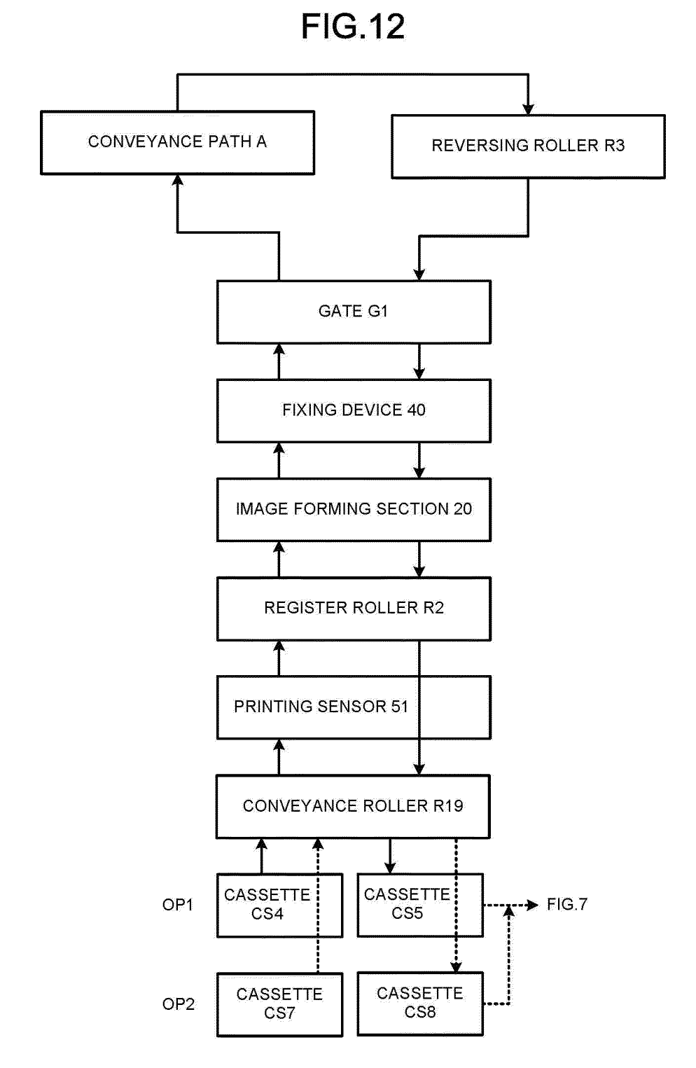

FIG. 12 is another illustration diagram illustrating the flow of the paper in a case of conveying the paper S on which an image is formed with the erasable toner. In FIG. 12, an example is described in which the paper S on which an image is formed with the erasable toner is stacked in the option cassette OP1 or the option cassette OP2. In a case of using the option cassette OP1, the paper is fed by the paper feed roller F4 from the cassette CS4 at the lower left of FIG. 12. In a case of using the option cassette OP2, the paper is fed by the paper feed roller F7 from the cassette CS7.

Further, the paper S is conveyed by the conveyance rollers R19 and R1, and the image formed on the paper S is read by the printing sensor 51. Then the paper S is conveyed by the register roller R2 via the image forming section 20 to the fixing device 40. At this time, the image forming section 20 passes the paper S through the secondary transfer roller 33 without carrying out image forming processing. The paper S conveyed to the fixing device 40 is heated at a temperature higher than the fixing temperature, in this way, the image formed on the paper S is erased.

After the image is erased, the paper S is conveyed to the gate G1. In a case where the front end of the gate G1 is directed downwards as shown by the dotted lines in FIG. 10, the paper S is conveyed in the direction of the conveyance path A; however, after the paper passes through the fixing device 40, the conveyance of the paper is stopped and the reversing roller R3 is rotated reversely, and other conveyance rollers are also rotated in an opposite direction.

Thus, the paper S is reversely conveyed towards the upstream side, and stacked in the cassette CS5 by the paper feed roller F5 of the cassette CS5 of the option cassette OP1 after passing through the switch gate G1, the fixing device 40, the image forming section 20, the register roller R2 and the conveyance roller R19. At this time, the paper is not read by the printing sensor 51. Alternatively, the paper S is stacked in the cassette CS8 by the paper feed roller F8 of the cassette CS8 of the option cassette OP2. The gates G4-G7 switch the stacking destination of the paper S to the cassette CS5 or the cassette CS8.

In the aforementioned procedure, the paper S the image on which is erased is stacked in the cassette CS5 or the cassette CS8 in sequence.

In a case of reusing the paper in the cassette CS5 to form a new image, the paper in the cassette CS5 can be taken out by the paper feed roller F5 and conveyed by the conveyance roller R18, and then subjected to the image forming processing on single side or both sides thereof through the same procedure as shown in FIG. 7.

Further, when the paper stacked in the cassette CS7 runs out and the cassette CS7 becomes empty, the paper S stacked in the cassette CS8 can be moved to the cassette CS7. In a case of reusing the paper in the cassette CS7 to form a new image, the paper in the cassette CS7 can be taken out by the paper feed roller F7 and conveyed by the conveyance roller R20, and then subjected to the image forming processing on single side or both sides thereof through the same procedure as shown in FIG. 7.

In accordance with the image forming apparatus according to the embodiment described above, the paper the image on which is erased by the fixing device 40 can be returned to the paper feed source (storage section 18) through the second conveyance path shared with the first conveyance path. Further, in a case of forming an image on the paper to be reused, there is no need to take trouble to supply new paper for the paper feed cassette, and the simplex printing or duplex printing can be carried out automatically and smoothly.

The present invention which is not limited to the embodiments described above can be applied to various cases. For example, the control on the conveyance section 173 and the fixing control section 174 may be carried out through a single control section (for example, the main CPU 101 or the printer CPU 171)

Further, the fixing device 40 described herein is provided with the fixing belt 41, however, a fixing device can be used as long as it is provided with the heating roller 42 and the pressing roller 43.

Besides the quadruple tandem type image forming apparatus, an image forming apparatus comprising an image forming section including a plurality of developing units may also be used. Further, it is exemplified that only the B toner used by the image forming section 20B is erasable, however, the erasable toner may also be used in other image forming sections 20C, 20M and 20Y.

Furthermore, an exposure unit including a laser source may also be used instead of the scanning heads 19C, 19M, 19Y and 19B including the LED elements.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus, comprising:
an image forming section configured to be capable of forming an image with erasable coloring agent;
an erasing section configured to heat the image receiving medium on which an image is formed with the erasable coloring agent at a pre-set temperature to erase the image;
a first conveyance path which passes through the image forming section and the erasing section;
a feed section configured to include a first cassette and a second cassette capable of feeding the image receiving medium to the first conveyance path;
a second conveyance path which passes towards the second cassette of the feed section from a downstream side of the erasing section; and
a control section configured to control conveyance of the image receiving medium stacked in the first cassette of the feed section towards a downstream direction through the first conveyance path which passes through the image forming section and the erasing section, and control conveyance of the image receiving medium the image on which is erased by the erasing section to the second cassette of the feed section through the second conveyance path, and control feeding the image medium stacked in the second cassette to the first conveyance path.

2. The image forming apparatus according to claim 1, wherein
the second conveyance path arranged separately from the first conveyance path is a dedicated conveyance path for conveying the image receiving medium the image on which is erased to the second cassette.

3. The image forming apparatus according to claim 1, wherein further comprising:
a plurality of conveyance rollers for conveying the image receiving medium to the erasing section through the first conveyance path and conveying the image receiving medium the image on which is erased by the erasing section to the second cassette through the second conveyance path,
a plurality of switches for detecting the image receiving medium passing through the first conveyance path and the second conveyance path, and
a drive section for rotating the plurality of conveyance rollers in response to the detection result of the plurality of switches.

4. The image forming apparatus according to claim 3, further comprising:
a gate configured at a branch point of the first conveyance path and the second conveyance path; wherein
the drive section drives the gate to carry out a control to guide the image receiving medium to either the first conveyance path or the second conveyance path.

5. The image forming apparatus according to claim 1, wherein
the second conveyance path shared with the first conveyance path conveys the image receiving medium the image on which is erased towards an upstream direction through the first conveyance path and guides the image receiving medium to the second cassette.

6. The image forming apparatus according to claim 5, further comprising:
a plurality of conveyance rollers arranged along the first conveyance path to be capable of rotating reversely,
a plurality of switches for detecting the image receiving medium passing through the first conveyance path, and
a drive section for driving and rotating, in response to the detection result of the plurality of switches, the plurality of conveyance rollers reversely after the image receiving medium passes through the fixing device and the image thereon is erased to convey the image receiving medium in a direction opposite to the direction of the first conveyance path and guide the image receiving medium to the second cassette.

7. The image forming apparatus according to claim 1, wherein
the feed section provided with the first cassette and the second cassette arranged in parallel includes a moving member for moving the image receiving media stacked in the second cassette to the first cassette when the second cassette is full of the stacked image receiving media while the first cassette becomes empty.

8. An image forming apparatus, comprising:
an image forming section configured to be capable of forming an image on an image receiving medium with erasable coloring agent;
a fixing device configured to heat the image formed by the image forming section to fix the image on the image receiving medium, and heat the image receiving medium at a temperature higher than the temperature applied during the fixing process to erase the image formed with the erasable coloring agent;
a first conveyance path which passes through the image forming section and the fixing device;
a feed section configured to include a first cassette and a second cassette capable of feeding the image receiving medium to the first conveyance path;
a second conveyance path which passes towards the second cassette of the feed section from a downstream side of the fixing device; and
a control section configured to control conveyance of the image receiving medium stacked in the first cassette of the feed section towards a downstream direction through the first conveyance path, and control conveyance of the image receiving medium on which an image is formed with the erasable coloring agent to the second cassette of the feed section through the second conveyance path after the image receiving medium is heated by the fixing device and the image thereon is erased, and control feeding the image receiving medium stacked in the second cassette to the first conveyance path.

9. The image forming apparatus according to claim 8, further comprising:
a plurality of conveyance rollers for conveying the image receiving medium stacked in the storage section to the fixing device through the first conveyance path and conveying the image receiving medium the image on which is erased by the fixing device to the second cassette through the second conveyance path,
a plurality of switches for detecting the image receiving medium passing through the first conveyance path and the second conveyance path, and
a drive section for driving the plurality of conveyance rollers in response to the detection result of the plurality of switches.

10. The image forming apparatus according to claim 8, further comprising:
a plurality of conveyance rollers arranged along the first conveyance path to be capable of rotating reversely,
a plurality of switches for detecting the image receiving medium passing through the first conveyance path, and
a drive section for driving and rotating, in response to the detection result of the plurality of switches, the plurality of conveyance rollers reversely after the image receiving medium passes through the fixing device and the image thereon is erased to convey the image receiving medium the image on which is erased towards an upstream direction through the first conveyance path and guide the image receiving medium to the second cassette.
